(19) United States
(12) Patent Application Publication
(10) Pub. No.: US 2008/0120707 A1
(43) Pub. Date: May 22, 2008

(54) Systems and methods for authenticating a device by a centralized data server

(76) Inventor: Alexander Ramia, Fallbrook, CA (US)

Correspondence Address: JONES DAY, 222 EAST 41ST ST, NEW YORK, NY, 10017, US

(21) Appl. No.: 11/603,446

(22) Filed: Nov. 22, 2006

(51) Int. Cl. H04L 9/32

(52) U.S. Cl. 726/5

(57) ABSTRACT

Systems, methods and apparatus for authenticating a query device using a centralized data server include associating and storing, on the server, for each respective device in a plurality of devices, a device identifier, a user identifier, and a synthesized security identifier that collectively authenticate the respective user device. An authentication request is received, at the centralized server, from an intermediary gateway server seeking verification of the query device. The request has a query device identifier or a query synthesized security identifier. Verification, at the centralized data server, of the query device is done by searching for a match between the query device identifier and a stored device identifier and a match between the query synthesized security identifier and a stored synthesized security identifier. The centralized data server communicates to the intermediary gateway server whether the identity of the query device is verified.

### 1. FIELD OF INVENTION

The field of this invention relates to systems and methods for authenticating identities of users and/or user devices. More specifically, the invention relates to authenticating user and/or user devices utilizing a device identifier (e.g., an IPv6 address), a user identifier (e.g., a biometric key) and a synthesized security identifier.

### 2. BACKGROUND OF THE INVENTION

Modern technology has provided greater convenience and economic freedom to individuals. For example, a credit card alleviates the need to carry large sums of cash and makes purchases of goods more efficient. The digital revolution and the pervasive use of computers or computer-based technologies have made it possible to transmit and exchange information between remote locations through connected networks. However, as more and more information, personal or financial, is embedded into various digital forms, security has become an increasing concern. In fact, identity theft has become an increasingly serious problem. For example, credit card fraud, mortgage fraud, and other kinds of financial fraud based on identity theft are increasingly common. Identity theft is also used to facilitate illegal immigration, terrorism and espionage.

Techniques for obtaining personal information include stealing mail or rummaging through garbage (dumpster diving), eavesdropping on public transactions to obtain personal data (shoulder surfing), stealing personal information from computer databases by hacking into the host computer system or by intersecting unencrypted or poorly encrypted information during transmission, infiltration of organizations that store large amounts of personal information, impersonating a trusted organization in an electronic communication, and using electronic spam to trick individuals into providing personal information. In addition, personal or corporate negligence can result in the dissemination of private information to unauthorized people. For instance, when a user accidentally remains logged on to a network in a public hotspot, a malicious user can take advantage of the situation and continue using the session disguised as the previous user.

Similarly, more and more sophisticated electronic gadgets (e.g., mobile devices such as personal digital assistants, cell phones, and laptop computers) are becoming the targets of theft. Stolen or lost gadgets can amount to considerable damages especially when identity theft is further committed using information stored on the stolen or lost gadgets. Surveys in the United States from 2003 to 2006 show a decrease in the total number of victims but an increase in the total value of identity fraud to U.S. $56.6 billion in 2006. The average fraud per victim rose from $5,249 in 2003 to $6,383 in 2006. The 2003 survey from the Identity Theft Resource Centre found that only about 73% of respondents indicated the crime involved the thief acquiring a credit card. Besides direct financial loss, additional economic and emotional loss is also substantial. The average time spent by victims resolving the problem is about 600 hours. The emotional impacts related to identity theft are similar to those of victims of violent crimes.

Identity theft and device theft is not limited to the United States. In Australia, identity theft was estimated to cost between $1 billion and $4 billion U.S. in 2001. In the United Kingdom in 2006, the Home Office reported that identity fraud costs the economy 2.16 billion U.S., arguing that the government should push for introduction of national identifier cards.

Given the above background, what is needed are methods and systems for creating and authenticating unique and secure identifiers for individuals and individual devices in real time.

### 3. SUMMARY OF THE INVENTION

The present application discloses methods for creating a synthesized security identifier for a query device that comprises the steps of: (a) submitting, to a centralized data server, data associated with the query device, where the data comprise information associated with a device identifier or a user identifier for the query device, and where the user identifier is not stored on the query device; (b) receiving, from the centralized data server, a synthesized security identifier at least partially based on the data from the submitting step (a); (c) storing the synthesized security identifier permanently on the query device; and (d) requesting a remote user session by transmitting (i) the device identifier and (ii) the synthesized security identifier.

In some embodiments, the query device is a cellular phone, a personal digital assistant (PDA), an iPod, a credit card, a mobile device equipped with a fingerprint scanner, a desktop computer, a laptop computer, or any networked device. In some embodiments, the query device is a credit card associated with a network device. In some embodiments, the query device is connected to a network through an external network module.

In some embodiments, the query device identifier is an IPv6 address. In some embodiments, the query device identifier is an IPv4 address, a public key infrastructure (PKI) key, a virtual private network (VPN) key, a radio frequency identification (RFID) tag number, a public key cryptography number, a credit card number, or a machine serial number.

In some embodiments, the user identifier associated with the query device comprises a biometric key. In some embodiments, the biometric key is extracted from biometric data from a user of the query device. In some embodiments, the biometric data comprises a measurement of a physical trait of the user selected from the group consisting of a facial thermogram, a finger print, an iris scan, and a hand geometry measurement. In some embodiments, the biometric data comprises a measurement of a physical trait of the user selected from the group consisting of a vein pattern, an ear shape, an analysis of a body odor, and an analysis of nucleic acid material obtained from the user. In some embodiments, the biometric data comprises a behavioral characteristic of the user selected from the group consisting of a hand signature pattern, a keystroke dynamic and a gait pattern. In some embodiments, the biometric data comprises a voice pattern of the user.

In some embodiments, the user identifier associated with the query device comprises a user password. In some embodiments, the synthesized security identifier associated with the query device is derived from the user identifier associated with the query device. In some embodiments, the synthesized security identifier associated with the query is derived from a biometric key associated with the query device. In some embodiments, the synthesized security identifier associated with the query device is derived from a device identifier.

In some embodiments, the device identifier associated with the query device is at least 32 bits in length, at least 128 bits in length, at least 256 bits in length. In some embodiments, the synthesized security identifier associated with the query device is up to 128 bits in length, up to 512 bits in length, and up to 2048 bits in length. In some embodiments, the user identifier associated with the query device is at least 16 bits in length, at least 32 bits in length, at least 64 bits in length, at least 256 bits in length.

In some embodiments, the submitting step (a) occurs on the query device. In some embodiments, the submitting step (a) occurs on a device external to the query device.

In some embodiments, the external device is an intermediary gateway server. In some embodiments, a backup access key associated with the query device is communicated to the centralized data server prior to the submitting step (a). In some embodiments, the backup access key is assigned to a query device with a device identifier. In some embodiments, the backup access key is associated with a plurality of query devices.

In some embodiments, the requesting step (d) further comprises transmitting user identifier or data comprising information associated with the user identifier.

The present application further discloses a method for authenticating a query device to a centralized data server. The method comprises the steps of: (a) associating and storing, on the centralized data server, for each respective device in a plurality of devices, a device identifier, a user identifier, and a synthesized security identifier that collectively authenticate the respective user device; (b) receiving, at the centralized data server, an authentication request that seeks verification of an identity of the query device, and the authentication request comprises a query device identifier, a query synthesized security identifier and a query user identifier; (c) attempting to verify, at the centralized data server, the query device by (i) searching for a match between the query device identifier and a stored device identifier, (ii) searching for a match between the query synthesized security identifier and a stored synthesized security identifier, and (iii) searching for a match between the query user identifier and a stored user identifier; and (d) communicating, from the centralized data server, whether the identity of the query device is verified to an intermediary gateway server.

In some embodiments, the authentication request is received at the centralized data center from an intermediary gateway server. In some embodiments, the authentication request is received at the centralized data center from a web interface. In some embodiments, the authentication request is received at the centralized data center from a telephone interface.

The present application further discloses a method for authenticating a query device to a centralized data server. The method comprises the steps of: (a) storing, on the query device, a device identifier and a synthesized security identifier that collectively authenticate the query device; (b) submitting an authentication request that comprises the device identifier or the synthesized security identifier and the synthesized security identifier is derived, at least in part, from an IPv6 address for the query device; and (c) receiving verification that there is a match between the query device identifier and a device identifier stored on the centralized data server and a match between the query synthesized security identifier and a synthesized security identifier stored on the centralized data server.

In some embodiments, the authentication request is submitted to an intermediary gateway server in the submitting step (b). In some embodiments, the authentication request is submitted to centralized data server in the submitting step (b). In some embodiments, the authentication request further comprises data that uniquely identifies the user of the query device.

In some embodiments, the data that uniquely identifies the user is a measurement of a physical trait of the user selected from the group consisting of a facial thermogram, a finger print, an iris scan, and a hand geometry measurement. In some embodiments, the data that uniquely identifies the user is a measurement of a physical trait of the user selected from the group consisting of a vein pattern, an ear shape, an analysis of a body odor, and an analysis of nucleic acid material obtained from the user. In some embodiments, the data that uniquely identifies the user comprises a behavioral characteristic of the user selected from the group consisting of a hand signature pattern, a keystroke dynamic and a gait pattern. In some embodiments, the data that uniquely identifies the user comprises a voice pattern of the user.

In some embodiments, the IPv6 address for the query device is the device identifier of the query device. In some embodiments, the receiving verification step (c) further comprises receiving access to a remote session. In some embodiments, the receiving verification step (c) further comprises receiving approval of a financial transaction.

The present application further discloses a query device that comprises a central processing unit and a computer readable memory coupled with the central processing unit. The computer readable memory includes instructions for authenticating the query device to a centralized data server by the steps of: (a) storing a device identifier and a synthesized security identifier in the computer readable memory that collectively authenticate the query device; (b) submitting an authentication request that comprises the device identifier or the synthesized security identifier and the synthesized security identifier is derived, at least in part, from an IPv6 address for the query device; and (c) receiving verification that there is a match between the query device identifier and a device identifier stored on the centralized data server and a match between the query synthesized security identifier and a synthesized security identifier stored on the centralized data server.

### 4. BRIEF DESCRIPTION OF THE DRAWINGS

FIG. 1A illustrates an exemplary embodiment of a triple authentication system in accordance with the present invention.

FIG. 1B illustrates an exemplary embodiment of a triple authentication system in accordance with the present invention.

FIG. 2 illustrates an exemplary embodiment of a user device in accordance with the present invention.

FIG. 3A illustrates an exemplary embodiment of a centralized data server in accordance with the present invention.

FIG. 3B illustrates an exemplary embodiment of a triple authentication system in accordance with the present invention.

FIG. 4 illustrates an exemplary embodiment of a registration process in accordance with the present invention.

FIG. 5 illustrates an exemplary embodiment of a network authentication process in accordance with the present invention.

FIG. 6 illustrates an exemplary embodiment of a purchase authentication process in accordance with the present invention.

FIG. 7 illustrates an exemplary embodiment of a triple authentication system in accordance with the present invention.

Like reference numerals refer to corresponding parts throughout the several views of the drawings.

### 5. DETAILED DESCRIPTION

Widespread identity theft demands novel and better methods and systems for protecting personal information as well as personal devices. The present invention utilizes a triple authentication system that employs a device identifier, a user identifier and a synthesized security identifier to uniquely identify a user as well as a user device. The triple authentication system, which in some embodiments utilizes IPv6 addresses, biometric keys and synthesized security identifiers, can be used to identify and protect user devices such as credit cards, mobile phones, laptop computers, and other devices. In particular, a triple authentication system can be used to safeguard network access and secure credit card-based purchase transactions. It can also help to protect and manage complex and compartmentalized data such as medical records.

### 5.1. Overview of the Invention

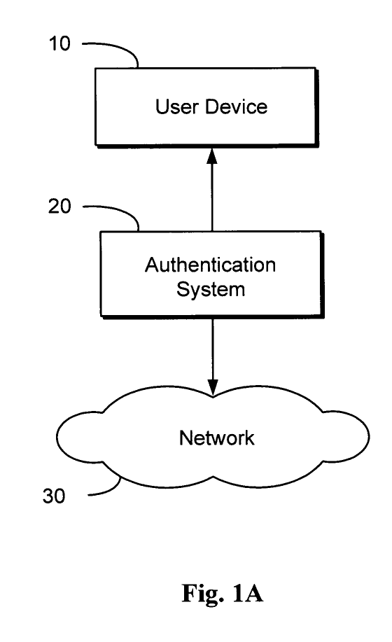

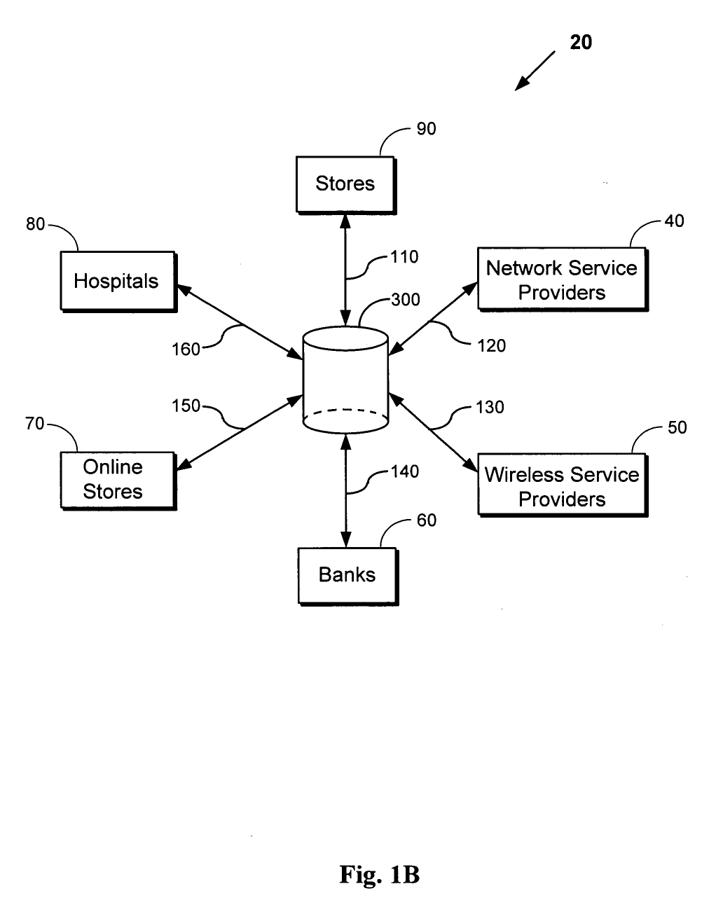

FIGS. 1A and 1B depict exemplary embodiments of triple authentication systems. In the most simplified embodiment as depicted FIG. 1A, a user or a user device 10 goes through a triple authentication system 20 before it reaches network 30, where triple authentication system 20 serves as a check point. An exemplary triple authentication system 20 is further depicted in FIG. 1B. At the core of triple authentication system 20 is centralized data server 300. Centralized data server 300 functions as an authentication center where verification of the identifiers takes place. In some embodiments in accordance with the present invention, intermediary gateway servers have to be pre-authorized to gain access to centralized data server 300. Examples of intermediary gateway servers 100 include, but are not limited to, network service providers 40, wireless service providers 50, banks 60, online stores 70, hospitals 80, and conventional brick and mortar stores 90. In some embodiments, requests for user or user device authentication are submitted to centralized data server 300 by such intermediary gateway servers. Centralized data server 300 then processes the authentication requests and conducts searches to determine if a user or user device 10 can be verified against the databases on centralized data server 300. If user or user device 10 can be verified, the authentication process is deemed complete and user or user device 10 may gain access to the services requested, otherwise error messages will be sent to user or user device 10, for example, through intermediary gateway servers. In some embodiments, additional measures (e.g., encryption methods) are taken to ensure the security of the identity of user or user device 10.

5.1.1. System Architecture

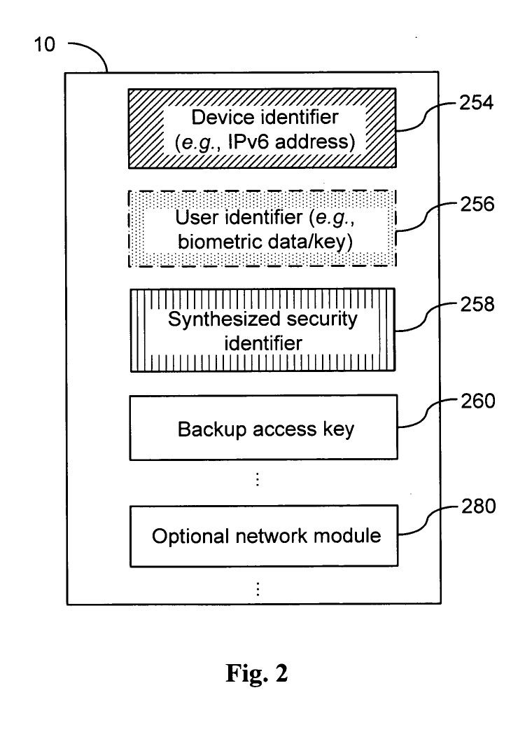

In order to ensure identity protection during transactions that do not require personal presence, it is necessary that a unique and personalized identification system be created first. The triple authentication system assigns highly unique and personalized identifiers to users or user devices. Specifically, a triple authentication system utilizes three types of identifiers: a device identifier (e.g., a device IPv6 address depicted as 254 FIG. 2), a user identifier 256 (e.g., user biometric data depicted as FIG. 2) and a synthesized security identifier (e.g., a synthesized security identifier depicted as 258 depicted as FIG. 2). This synthesized security identifier is extremely unique and highly encrypted, which ensures secure network communication between a user or a user device 10 and any network services.

5.1.1.1 User or User Device

FIG. 2 depicts an exemplary embodiment of a user device 10, in accordance with the present invention. In order to be verified by a triple authentication system, a user device 10 comprises a device identifier 254 (e.g., an IPv6 address), a synthesized security identifier 258 and a backup access key 260. User identifiers 256 (e.g., a biometric key) are associated with user devices 10. However, in most embodiments in accordance with the present invention, user identifiers 256 are not stored on user device 10, as depicted by the dashed line for the block representing user identifiers 256 in FIG. 2. In some embodiments in accordance with the present invention, a user device 10 is also equipped with one or more optional network modules 280 such that user device 10 has the capacity to request and receive network services. For example, user device 10 can be a cell phone, a personal digital assistant (PDA), an iPod, or any other mobile devices. In some embodiments in accordance with the present invention, a user device 10 has an additional module for collecting biometric data. For example, a PDA or cell phone may be equipped with a fingerprint scanner. In another example, a PDA or cell phone may have a jack for a cable that connects with a fingerprint scanner, eye scanner, or other form of biometric entry device. In some embodiments, a user device such as a laptop computer may be equipped with more sophisticated biometric collecting devices such as an eye scanner.

In some embodiments, user devices 10 are credit cards that communicate with centralized data servers through credit card reader devices. In some embodiments, user devices 10 are laptop computers that can connect to the Internet through local area network or wireless network connections. In some embodiments, user devices 10 are portable battery operated handheld devices whose primary source of communication with other devices is through the use of a cellular communication protocol. Examples of user devices 10 include, but are not limited to, cellular telephones, smart phones, pagers, various forms of personal digital assistants (PDAs), and Internet appliances. In some embodiments, a user device 10 weighs less than half a pound and, more typically, weighs less than 5 to 8 ounces. In some embodiments, user devices 10 use cellular networks that include but are not limited to frequency division multiple access (FDMA), code division multiple access (CDMA), polarization division multiple access (PDMA), and time division multiple access (TDMA). In some embodiments, user device 10 does not have network capacity but is associated with another device that has network capacity. For example, a credit card with an embedded IPv6 address and a synthesized security identifier 258 may be bundled with a cellular phone or PDA device. In some embodiments, when the credit card number is entered during a financial transaction, a request for a user identifier will be prompted on the associated cellular phone or PDA device.

In more complex embodiments in accordance with the present invention, a user or user device 10 can be an individual, a group of individuals, or an information system characterized by compartmentalized data (e.g., medical records). In some embodiments, user device 10 can have multiple device identifiers 254, each of which represents a part of the functionality of the device or a segment of the data stored on the device.

In some embodiments in accordance with the present invention, when a user device 10 is purchased from a store or online, it is already equipped with a unique device identifier 254 (e.g., IPv6 address) as well as a backup access key 260. In some embodiments, synthesized security identifier 258 is synthesized based on biometric information of the device owner, for example, a fingerprint scan or an eye scan of the owner. An exemplary process for creating a synthesized security identifier is described in Section 5.1.2, below.

5.1.1.2 Identifiers

The three types of identifiers will now be discussed in further detail.

Device identifier 254. A device identifier 254 is any information that can accurately identify a user or a user device. An Internet Protocol version 6 (IPv6) address is used herein as an example of a device identifier 254. The scope of the invention, however, is not limited to the use of IPv6 addresses as device identifiers 254. It is possible for a device identifier 254 to be assigned with a level of arbitrariness. Accordingly, there is almost no restriction as to what a device identifier can be. For example, a device identifier can also be an IPv4 address, a public key infrastructure (PKI) key, a virtual private network (VPN) key, or any cryptographic keys that can be used to uniquely identify a device. In some embodiments, it is possible to have multiple device identifiers (e.g., IPv6 addresses) assigned to the same device so long as the assigned device identifiers 254 each uniquely identify the device. In addition, one or more encoding or encryption algorithms or methods may be applied to further enhance the security of device identifiers 254.

In some embodiments, an IPv6 address may be assigned to an individual or an aspect of an individual. IPv6 is a network layer IP standard used by electronic devices to exchange data across a packet-switched network. It follows Internet Protocol version 4 (IPv4) as the second version of the Internet Protocol to be formally adopted for general use. The main improvement brought by the IPv6 standard is the increase in the number of IP addresses available for networked devices. For example, the IPv6 standard has the capacity to allow each cell phone and mobile electronic device to have its own IPv6 address or even multiple IPv6 addresses. IPv4 supports 4.3×10⁹ (4.3 billion) IP addresses, which is inadequate for giving even one IP address to every living person, much less support the burgeoning emerging market for user devices with network capacity. The IPv6 standard supports 3.4×10³⁸ IP addresses. In an IPv6 system, each of the roughly 6.5 billion people alive today can have 5×10²⁸ (50 octillions) IP addresses. Alternatively, each gram of matter in the Earth can be assigned nearly 57 billion IP addresses.

IPv6 is advantageous over the existing prevalent IPv4 system in many aspects. First, under IPv6, IP addresses can be assigned to users with no or little limitation. The main feature of IPv6 is the larger address space: addresses in IPv6 are 128 bits long versus 32 bits in IPv4. The larger IP address capacity under IPv6 eliminates the danger of exhausting the existing IPv4 IP addresses without the need for additional technologies such as classless inter-domain routing (CIDR) and network address translation (NAT) and other devices that break the end-to-end nature of Internet traffic. Second, because IPv6 IP addresses are plentiful, it is reasonable to allocate addresses in large blocks, which makes administration easier and avoids fragmentation of the address space, which in turn leads to smaller routing tables. Third, a technical reason for selecting 128-bit for the address length is that, since most future network products will be based on 64 bit processors, it is more efficient to manipulate 128-bit addresses. A drawback of the large address size is that IPv6 is less efficient in bandwidth usage, and this may hurt regions where bandwidth is limited. Fourth, larger address space makes scanning certain IP blocks for vulnerabilities significantly more difficult, which renders IPv6 more resistant to malicious Internet traffic than IPv4. Finally, because the IPv6 standard, in most aspects, is a conservative extension of the IPv4 standard, an IPv6 upgrade requires little or no change to most transport or application-layer protocols.

More detailed discussion on the IPv6 standard can be found in Huitema, 1998, “IPv6: The New Internet Protocol,” Prentice Hall PTR; 2^{nd} edition; Hagen, 2006, “IPv6 Essentials,” O'Reilly & Associates, 2^{nd} edition; and Blanchet, 2006, “Migrating to IPv6: A Practical Guide to Implementing IPv6 in Mobile and Fixed Networks,” John Wiley & Sons; 1st edition; each of which is hereby incorporated by reference herein in its entirety.

Using, for example, the IPv6 standard, each user or user device 10 can be assigned one or more unique device identifiers 254 (e.g., IPv6 addresses). The inherent network security related to an IPv6 address or another device identifier 254 created in accordance with the present invention is the first feature in the triple authentication system disclosed in the present invention.

In some embodiments in accordance with the present invention, auxiliary authentication systems may be necessary where one device identifier 254 is associated with multiple user identifiers 256 or synthesized security identifiers 258.

User identifier 256. A user identifier 256 refers to any information that may accurately and uniquely identify and authenticate an individual. Biometric data itself and biometric keys extracted from biometric data are two examples of user identifiers in accordance with the systems and methods of the present invention. This, however, should not limit the scope of the present invention. Any information or data that can uniquely identify a user may be used to create a user identifier 256. In some embodiments, user identifier 256 is submitted interactively from a user upon request. In some embodiments, when a biometric collecting device is not available to generate a biometric key that serves as user identifier 256, a unique user-defined password may be submitted as user identifier 256 in place of the biometric data.

Biometrics is the study of automated methods for uniquely recognizing humans based upon one or more intrinsic physical or behavioral traits. In information technology, a biometric authentication process uses technologies that measure and analyze human physical and behavioral characteristics (e.g., biometric data) for authentication purposes. Examples of physical characteristics include measurement of physical traits such as faces (e.g., facial thermogram), fingerprints, eyes (e.g., iris scan and retinal scan), hands (e.g., hand geometry measurements), body odor, ear (e.g., ear shapes), vein patterns, and nucleic acid (e.g., unique nucleic acid sequences, unique nucleic acid markers such as single nucleotide polymorphisms). Examples of mostly behavioral characteristics comprise signature, keystroke dynamics, and gait pattern. Voice is considered a mix of both physical and behavioral characteristics. Although each of the aforementioned forms of biometrics is capable of uniquely identifying an individual, in some embodiments, it is advantageous to establish systems that combine several biometric data forms (e.g., combine an eye scan with a fingerprint scan from a single individual) to further increase the accuracy and security in identity authentication.

A biometric data type can be selected after one or more factors are evaluated to ensure such biometric data can serve as a unique identifier, or part of a unique identifier, for a person. A digitized version of such an identifier in accordance with the present invention is called a biometric key. Exemplary factors associated with selecting biometric data include, but are not limited to, universality, uniqueness, permanence, collectability, performance, acceptance and circumvention. For example, universality indicates how common the biometric is found in each person. Uniqueness indicates how well the biometric separates one person from another. Permanence indicates how well the biometric resists the effect of aging, while collectability measures how easy it is to acquire the biometric for processing. Performance indicates the achievable accuracy, speed and robustness of the biometrics while acceptability indicates the degree of acceptance of the technology by the public in their daily life. Circumvention indicates the level of difficulty of circumventing or fooling the system into accepting an impostor.

As with many interesting and powerful technological developments, there are concerns about biometrics. The biggest concern is the fact that once a fingerprint or other biometric source has been compromised, it is compromised for life, because users can never change their fingerprints. Theoretically, stolen biometric keys or biometric data can haunt a victim for decades. Accordingly, biometric keys and biometric data must be guarded with extreme caution. However, data variations are an inherent part of the measurement of biometric data. For example, an individual takes a thumbprint scan and stores the scan on a computer as an original template. This individual then takes multiple thumbprint scans and compares the scanned images to the original template on file. Factors such as the relative position of the thumb to the scanner and the relative strength at which the thumb is pressed against the scanner may affect the quality and characteristics of the final scanned images. Therefore, even though the subsequently scanned thumbprints will suffice to correctly identity an individual, none of these subsequently scanned images will likely be identical to the stored template image. On the contrary, stolen biometric keys or biometric data perfectly match the stored templates and thus should raise suspicion. Accordingly, some embodiments of the present invention make use of design identification algorithms that take into consideration the “perfect match” scenarios to recognize and thus deter theft of biometric keys or biometric data.

More detailed discussion of biometrics and biometric data is found in Wayman et al., 2004, “Biometric Systems: Technology, Design and Performance Evaluation,” Springer, 1^{st} edition; Woodward et al., 2002, “Biometrics,” Mcgraw-Hill Osborne Media, 1^{st} edition; Nanavati et al., 2002, “Biometrics: Identity Verification in a Networked World,” Wiley; 1^{st} edition; and Ross et al., 2006, “Handbook of Multibiometrics: International Series on Biometrics,” Springer, 1^{st} edition; each of which is hereby incorporated by reference herein in its entirety.

Using biometric data, the identity of a user as well as the device being used can be verified dynamically, for example, by requesting a user to submit biometric data at a time of financial transaction. The inherent security and individuality that is associated with biometric data and biometric keys is the second feature of the triple authentication system disclosed in the present invention.

Due to the inherent security sensitivity of biometric data, in most embodiments in accordance with the present invention, biometric data or any other form of user identifier will not be stored on user device 10. Instead, biometric keys are transported to a centralized data server 300 as depicted in FIG. 1B. Only authorized intermediary gateway servers 100 will have access to centralized data server 300, e.g., network service providers 40, wireless service providers 50, banks 60, online stores 70, hospitals 80, and conventional stores 90, as depicted in FIG. 1B. In some embodiments in accordance with the present invention, intermediary gateway servers 100 can only submit biometric data for verification on centralized data server 300 but cannot read such biometric data. In such embodiments, a downloading option for biometric data from centralized data server 300 is not available.

In some embodiments in accordance with the present invention, a user identifier 256 can be associated with one or more unique device identifiers 254 or synthetic security identifiers 258. For example, a device 10 may be linked with multiple user identifiers 256, where each user identifier 256 is for an authorized user of the equipment. Similarly constructs other than devices, such as data or records, may be associated with one or more unique user identifiers (e.g., biometric keys). For example, medical records (e.g., device 10) of a patient may be associated with multiple user identifiers 256, where each user identifier 256 is for an authorized medical professional. Alternatively, a medical professional may have a user identifier 256 associated with multiple patients' medical records, each represented by a device identifier 254 such as an IPv6 address. Alternatively, authentication of a medical professional may be achieved using a synthesized security identifier 258.

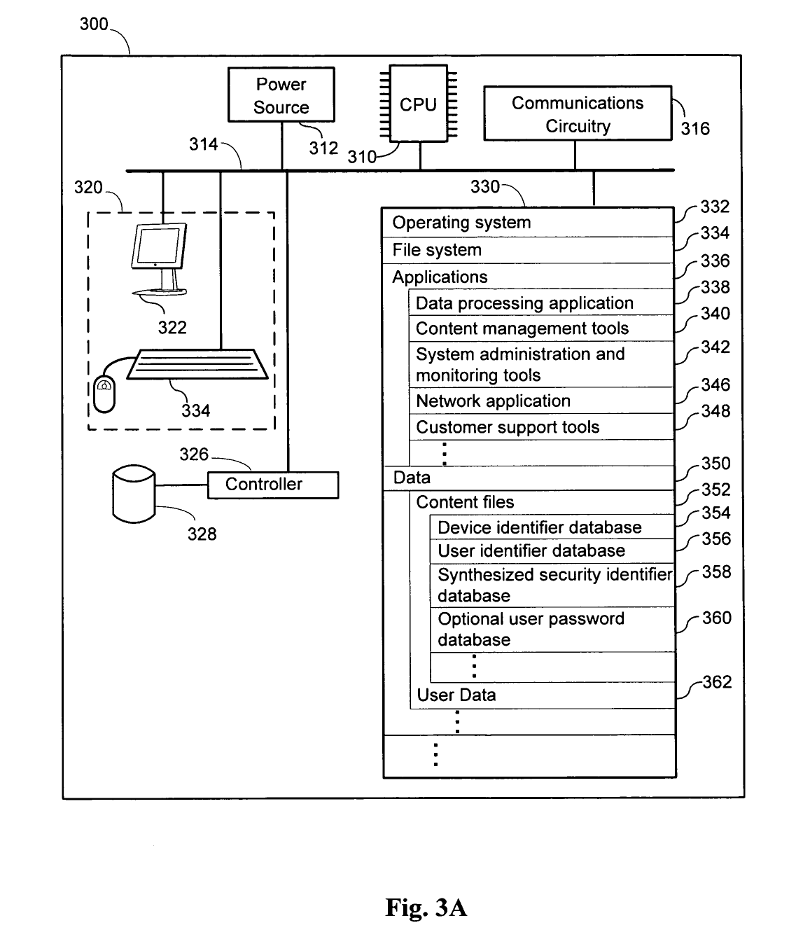

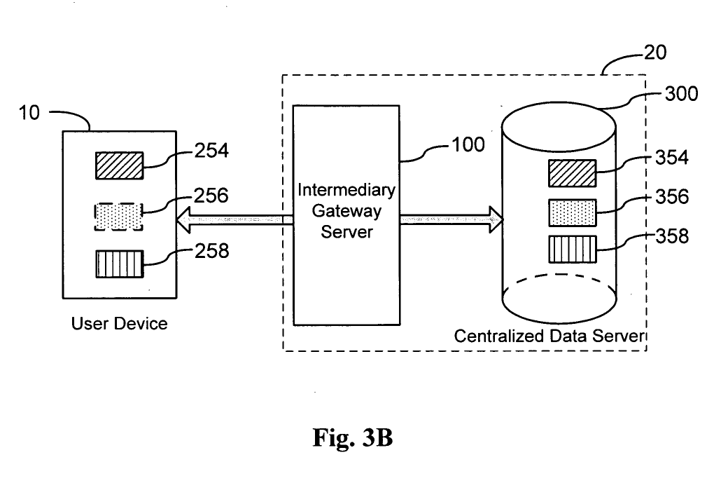

In the examples and methods described below, it will be appreciated that in some instances, a user identifier 256 is generated from biometric data. This generation process, in some embodiments, occurs within device 10 and then the user identifier 256 is communicated to a centralized data server 300, typically via a gateway server (e.g., gateway server 100 of FIG. 3B or any of the gateway servers illustrated in FIG. 1B). This generation process, in some embodiments, occurs at centralized data server 300. In such embodiments, the biometric data acquired at device 10 is communicated to a central server 300, typically via a gateway server (e.g., gateway server 100 of FIG. 3B or any of the gateway servers illustrated in FIG. 1B). Once the biometric data is received by server 300, it is processed in order to form the user identifier 256. In some embodiments, unless explicitly taught otherwise, a user identifier 256 may be the biometric data itself without subsequent conversion to a biometric key. In such embodiments, the biometric data is communicated to the centralized data server 300 where it is stored without a biometric key conversion step.

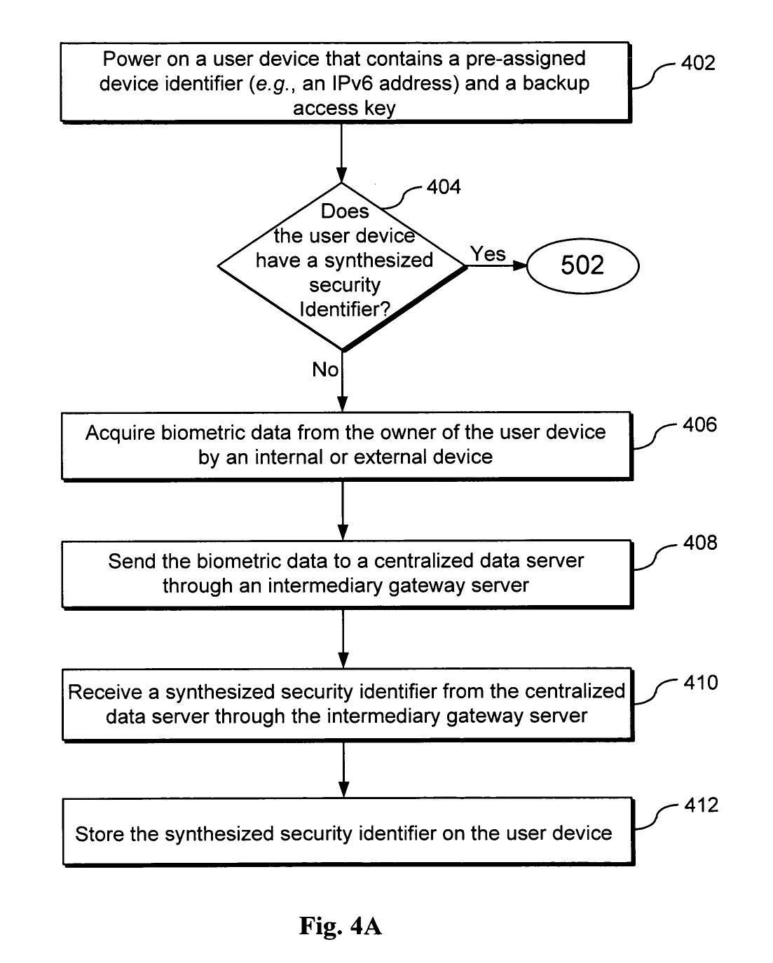

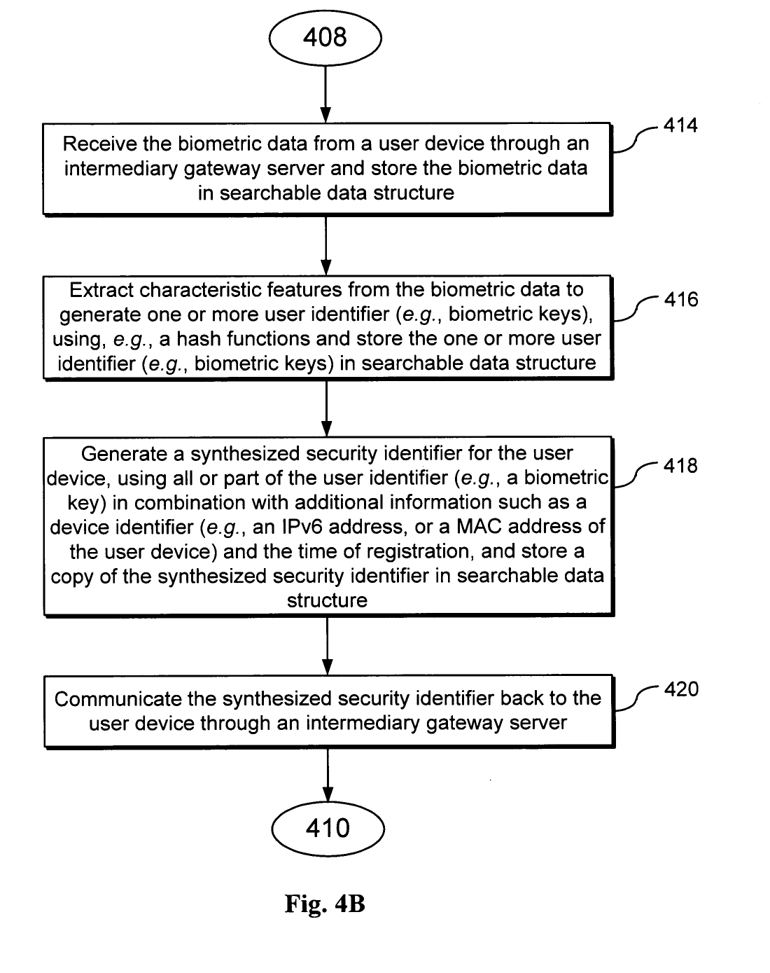

Synthesized security identifier 258. The third feature of the triple authentication system disclosed in the present invention is a synthesized security identifier (e.g., depicted as 258 in FIG. 2). In typical embodiments, a synthesized security identifier 258 is stored on both user device 10 and centralized data server 300. Unlike an IPv6 address, a synthesized security identifier 258 is not assigned, but created through a registration or initiation process. An exemplary embodiment of the registration process is depicted in FIG. 4A in steps 402 through 412 and will be discussed in details in Section 5.1.2.

A typical synthesized security identifier 258 in accordance with the present invention is 512 bits long. In some embodiments, a synthesized security identifier 258 is created based on a plurality of factors that include an IPv6 address, the user's biometric data, and time of registration. The following formula describes one method for creating a synthesized security identifier 258 according to an embodiment of the present invention:

$$\text{synthesized security identifier} = AA * \frac{TT}{BB} * \frac{( TT + MAC )}{( BB + MAC )} * ST ,$$

where
AA is at least a part of a 128 bit IPv6 address;
BB is a biometric key (e.g., a 40 bit number that corresponds to a 40-point fingerprint scan);
TT is a time (e.g., the time when a biometric key is acquired);
MAC is the device media access control address (e.g., a MAC address is a unique 48 bits long identifier attached to most forms of networking equipment); and
ST is a system network time (e.g., a 11 bit long number that reflects the time when a synthesized security identifier is generated on centralized data server 300).

In some embodiments, synthesized security identifier 258 is generated by, for example, combining information from a public key infrastructure (PKI) server with an IPv6 address. In some embodiments, a PKI server may be used to directly generate the synthesized security identifiers. A common PKI server application works by exchanging, for example, a data encryption standard (DES) key or an RSA key (generated by a public-key encryption algorithm) to authenticate users. PKI servers sometimes are used to provide possible VPN keys on IPv4 networks. In some embodiments, the PKI server output is a 64 to 256 bit long key. Binding this key to an IPv6 address in a dynamic real-time fashion will ensure secure communications and can substitute a synthesized security identifier 258 based on biometric. In some embodiment, unique synthesized security identifiers 258 may be generated from other peripheral information that includes an RFID tag number, a public key cryptography number, a machine serial number, or any other data that can be used to create a unique identifier.

It is to be appreciated that synthesized security identifiers 258 are created with a certain degree of variability, largely because of the variability of device identifier 254. A minimum requirement for a synthesized security identifier 258 is that it comprises information from a device 10 that is sufficient to uniquely identify the device and information from a user of the device 10 which is sufficient to uniquely identify the user.

As shown in the example below, the multi-component synthesized security identifiers 258 are highly personalized and difficult if not impossible to re-create. In some embodiments, a synthesized security identifier 258 is between 128 and 512 bits in length. In some embodiments, a synthesized security identifier 258 is up to 1024 bits in length. In some embodiments, a synthesized security identifier 258 is up to 2048 bits in length. In some embodiments, a synthesized security identifier 258 may be more than 2048 bits in length. Advantageously, the level of protection provided for a specific application of a triple authentication system can be adjusted based on the sensitivity of the application. For example, using conventional crypto cracking algorithms and a computer system running the algorithms non-stop for 24 hours a day, seven days a week, it would take about 52 years to exhaust all the combination of a 512 bit long security code. Accordingly, to ensure protection for a patient's medical records, a synthesized security identifier 258 for medical records may be designated at 1024 bits in length, thus ensuring data protection throughout the patient's life span. In some embodiments, additional encryption methods may be implemented for further enhanced security.

In some embodiments in accordance with the present invention, it is possible that one synthesized security identifier 258 is associated with multiple device identifiers 254 or user identifiers 256. Because synthesized security identifiers 258 are generated by centralized data server 300, it is possible that they can be modified to alter the authentication level for specific users. For example, a synthesized security identifier 258 may be revoked from a defined device identifier 254 encoding medical records for a patient. As a result, a medical professional associated with the synthesized security identifiers 258 would no longer have access to the patient's records.

In some embodiments, a user identifier 256, a device identifier 254, or a synthesized security identifier 258 may be derived using one or more encoding, encryption or mathematical algorithm. In some embodiments, the association between a user identifier 256, a device identifier 254, and a synthesized security identifier 258 may be modified upon request.

5.1.1.3 Centralized Data Server

FIG. 3A illustrates an exemplary system for a centralized data server 300 that supports the functionality described above and detailed in sections below.

In some embodiments, centralized data server 300 may comprise a central processing unit 310, a power source 312, a user interface 320, communications circuitry 316, a bus 314, a controller 326, an optional non-volatile storage 328, and at least one memory 330.

Memory 330 may comprise volatile and non-volatile storage units, for example random-access memory (RAM), read-only memory (ROM), flash memory and the like. In preferred embodiments, memory 330 comprises high-speed RAM for storing system control programs, data, and application programs, e.g., programs and data loaded from non-volatile storage 328. It will be appreciated that at any given time, all or a portion of any of the modules or data structures in memory 330 can, in fact, be stored in memory 328.

User interface 320 may comprise one or more input devices 324, e.g., keyboard, key pad, mouse, scroll wheel, and the like, and a display 322 or other output device. A network interface card or other communication circuitry 316 may provide for connection to any wired or wireless communications network, which may include the Internet and/or any other wide area network, and in particular embodiments comprises a telephone network such as a mobile telephone network. Internal bus 314 provides for interconnection of the aforementioned elements of centralized data server 300.

In some embodiments, operation of centralized data server 300 is controlled primarily by operating system 332, which is executed by central processing unit 310. Operating system 332 can be stored in system memory 330. In addition to operating system 332, a typical implementation system memory 330 may include a file system 334 for controlling access to the various files and data structures used by the present invention, one or more application modules 336, and one or more databases or data modules 350.

In some embodiments in accordance with the present invention, applications modules 336 may comprise one or more of the following modules described below and illustrated in FIG. 3A.

Data Processing Application 338. In some embodiments in accordance with the present invention, a data processing application 338 receives and processes biometric data. Biometric data are delivered to centralized data server 300 from user devices 10 or from external biometric acquiring devices associated with authorized intermediary gateway servers 100. Biometric data, once received, are processed to extract the essential features to generate templates of biometric keys to be used as references in future comparison analyses. For example, information of 40 key positions of a fingerprint scan can be extracted to create a template that encodes the individualized information about a particular user. In some embodiments, extraction of biometric data is achieved before the extracted biometric keys are delivered to centralized data server 300. In some embodiments, a hash function is used to perform the information extraction. A hash function (or hash algorithm) is a reproducible method of turning data (usually a message or a file) into a number suitable to be handled by a computer. Hash functions provide a way of creating a small digital “fingerprint” from any kind of data. The function chops and mixes (e.g., bit shifts, substitutes or transposes) the data to create the fingerprint, often called a hash value. The hash value is commonly represented as a short string of random-looking letters and numbers (e.g., binary data written in hexadecimal notation). A good hash function is one that yields few hash collisions in expected input domains. In hash tables and data processing, collisions inhibit the distinguishing of data, making records more costly to find. Hash functions are deterministic. If two hash values derived from two inputs using the same function are different, then the two inputs are different in some way. On the other hand, a hash function is not injective, e.g., the equality of two hash values ideally strongly suggests, but does not guarantee, the equality of the two inputs. Typical hash functions have an infinite domain (e.g., byte strings of arbitrary length) and a finite range (e.g., bit sequences of some fixed length). In certain cases, hash functions can be designed with one-to-one mapping between identically sized domain and range. Hash functions that are one-to-one are also called permutations. Reversibility is achieved by using a series of reversible “mixing” operations on the function input. If a hash value is calculated for a piece of data, a hash function with strong mixing property ideally produces a completely different hash value each time when one bit of that data is changed.

By applying computation techniques (e.g., hash functions), data processing application 338 turns raw biometric data (e.g., a scan image of a fingerprint or iris pattern) into digital data: biometric keys. In some embodiments in accordance with the present invention, the digitized biometric keys are stored on centralized data server 300 and used as templates during future comparison processes. In some embodiments in accordance with the present invention, the non-digitized biometric data are also stored on centralized data server 300. In some embodiments, biometric data are processed using more than one algorithm to create multiple biometric keys to ensure accuracy.

Content Management Tools 340. In some embodiments, content management tools 340 are used to organize different forms of content files 352 into multiple databases, e.g., a device identifier database 354, a user identifier database 356, a synthesized security identifier database 358, and an optional user password database 360. In some embodiments in accordance with the present invention, content management tools 340 are used to search and compare synthesized security identifiers and biometric keys. For example, during a financial transition, a user enters his or her biometric data upon request. The biometric data is processed by data processing application 338 to form a user identifier 256 and then transferred to content management tools 340 to search for a match or a near match among the user identifiers 256 in user identifier database 356 stored on centralized data server 300.

The databases stored on centralized data server comprise any form of data storage system including, but not limited to, a flat file, a relational database (SQL), and an on-line analytical processing (OLAP) database (MDX and/or variants thereof). In some specific embodiments, the databases are hierarchical OLAP cubes. In some embodiments, the databases each have a star schema that is not stored as a cube but has dimension tables that define hierarchy. Still further, in some embodiments, the databases have hierarchy that is not explicitly broken out in the underlying database or database schema (e.g., dimension tables are not hierarchically arranged). In some embodiments, the databases in fact are not hosted on centralized data server 300 but are in fact accessed by centralized data server through a secure network interface. In such embodiments, security measures such as encryption is taken to secure the sensitive information stored in such databases.

System Administration and Monitoring Tools 342. In some embodiments in accordance with the present invention, system administration and monitoring tools 342 administer and monitor all applications and data files of centralized data server 300. Because security sensitive data such as biometric keys are stored on centralized data server 300, it is important that access those files that are strictly controlled and monitored. System administration and monitoring tools 342 determine which servers or devices have access to centralized data server 300. In some embodiments, security administration and monitoring is achieved by restricting data download access from centralized data server 300 such that the data are protected against malicious Internet traffic. In some embodiments, system administration and monitoring tools 342 use more than one security measure to protect the data stored on centralized data server 300. In some embodiments, a random rotational security system may be applied to safeguard the data stored on centralized data server 300.

In some embodiments in accordance with the present invention, system administration and monitoring tools 342 communicate with other application modules on centralized data server 300. In some embodiments, before a user device 10 is registered with centralized data server 300, initial access to centralized data server 300 is granted by a backup access key 260 that has been assigned to user device 10 along with an IPv6 address. In some embodiments, backup access key 260 is recognized and monitored by system administration and monitoring tools 342.

Network Application 346. In some embodiments, network applications 346 connect a centralized data server 300 with intermediary gateway servers. Referring to FIG. 1B, a centralized data server 300 is connected to multiple types of gateway servers (e.g., network service providers 40, wireless service provides 50, banks 60, online stores 70, hospitals 80, and stores 90). These gateway servers have different types of network modules. Therefore, it is possible for network applications 346 on a centralized data server 300 to be adapted to different types of network interfaces, for example, router based computer network interface, switch based phone like network interface, and cell tower based cell phone wireless network interface, for example, an 802.11 network or a Bluetooth network. In some embodiments in accordance with the present invention, upon recognition, a network application 346 receives data from intermediary gateway servers before it transfers the data to other application modules such as data processing application 338, content management tools 340, and system administration and monitoring tools 342.

Customer Support Tools 348. Customer support tools 348 assist users with information or questions regarding their accounts, technical support, billing, etc. In some embodiments, customer support tools 348 may further include a lost device report system to protect ownership of user devices 10. When a user device 10 is lost, the user of the device can report to centralized data server 300 through customer support tools 348, for example, by calling a customer support number, through a web-based interface, or by E-mail. When a cell phone is reported lost or stolen, customer support tools 348 communicates the information to content management tools 340, which then searches and locates the synthesized security identifier 258 associated with the particular user device 10. In some embodiments, a request for authentication will be sent to user device 10, requiring that a biometric key be submitted to centralized data server 300. In some embodiments, if a valid biometric key is not submitted within a pre-determined time period, network access or any other services will be terminated for user device 10. In some embodiments, when user devices 10 are of high value, synthesized security identifier 258 and device identifier 254 (e.g., IPv6 address) may be used to physically locate the position of the alleged lost device.

In some embodiments, each of the data structures stored on centralized data server 300 is a single data structure. In other embodiments, any or all such data structures may comprise a plurality of data structures (e.g., databases, files, and archives) that may or may not all be stored on centralized data server 300. The one or more data modules 350 may include any number of content files 352 organized into different databases (or other forms of data structures) by content management tools 340:

In addition to the above-identified modules, data 350 may be stored on server 300. Such data comprises content files 352 and user data 362. Exemplary contents files 352 (device identifier database 354, user identifier database 356, synthesized security identifier database 358, and optional user password database 360) are described below.

Device Identifier Database 354. Since IPv6 addresses have been provided as the primary example of a device identifier 254, a device identifier database 354 is discussed herein using an IPv6 address database as an example. However, it will be appreciated that device identifier database 354 is a database of device identifiers 254 in whatever form such device identifiers 254 are found.

A database of IPv6 addresses comprises blocks of IPv6 addresses. Unlike IPv4 addresses, which are growing more and more scarce, the IPv6 standard makes assignment of large blocks of IPv6 addresses possible. In some embodiments, an IPv6 address database is pre-compiled on centralized data server 300. IPv6 address within the databases are then sold or assigned in blocks to companies or users. In some embodiments, IPv6 addresses are assigned during transactions between users and intermediary gateway servers. In other embodiments, IPv6 addresses may be submitted to centralized data server 300 by users or user devices 10, for example, through intermediary gateway servers via network 30.

Using the IPv6 standard, it is possible for users and user devices 10 to acquire unique IP addresses. In some embodiments in accordance with the present invention, an IPv6 address is an integral part of users and user devices 10, as depicted in FIG. 2. Once an IPv6 address is assigned, it is extremely difficult if not impossible to alter the IPv6 address of a user device 10. Accordingly, an assigned IPv6 address exclusively accounts for one user or one user device 10. The uniqueness of an IPv6 address allows a user or a user device to be detected and/or tracked on an IPv6 network. It is, however, possible to assign multiple IPv6 addresses to a single user or user device 10.

User identifier database 356. In some embodiments, a user identifier database 356 comprises both user identifiers 256 (FIG. 2) and biometric data. In some embodiments, user identifiers 256 and biometric data are organized into separate databases. User identifiers 256 and biometric data differ from each other in that user identifiers 256 are digitized information extracted from raw biometric data such as scanned images of fingerprints, iris scans, etc. In some embodiments, when user identifiers 256 need to be authenticated because of a suspected biometric theft, the original biometric data can be retrieved and re-processed for additional verification purpose.

It is to be appreciated that databases, especially user identifier database 356, on centralized data server 300 is protected by restricting access to only authorized intermediary gateway servers 100. In some embodiments, data download from centralized data server 300 is prohibited.

Synthesized Security Identifier Database 358. A synthesized security identifier database 358 comprises the synthesized security identifiers 258 after they are synthesized based on device identifiers 254, user identifiers 256, and, optionally, other elements such as MAC addresses, current activation time etc. Once a synthesized security identifier 258 is created, a copy of the identifier is communicated to a user device 10 through network 30 via intermediary gateway servers. Each synthesized security identifier 258 within the database uniquely identifies a user and/or a user device 10. In some embodiments, each time a user device 10 attempts to access network 30, it submits its synthesized security identifier 258 to centralized data server 300 for verification, for example, via intermediary gateway servers 100. Once accepted, user device 10 can access network services without restriction unless a financial transaction is further requested. Then a user identifier key 256 will be required to further identify the user and/or user device 10.

Optional User Password Database 360. In some embodiments in accordance with the present invention, an optional user password is submitted for user verification instead of a user identifier key 256. In these embodiments, the third element in the triple authentication system is an optional user password. An optional user password is particularly useful where devices for collecting biometric data are not available.

In some embodiments, databases on centralized data server 300 are distributed to multiple sub-servers. In some embodiments, a sub-server hosts identical databases as those found on centralized data server 300. In some embodiments, a sub-server hosts only a portion of the databases found on centralized data server 300. In some embodiments, global access to a centralized data server 300 is possible for users and user devices regardless of their locations. In some embodiments, access to a centralized data server 300 may be restricted to a subset of users and user devices 10, for example, employees of the same company.

5.1.1.4 Intermediary Gateway Server

Another integrated part of a triple authentication system are intermediary gateway servers (e.g., Internet or network service providers 40, wireless service providers 50, banks 60, online stores 70, hospitals 80, and conventional stores 90 as depicted in FIG. 1B). In some embodiments, an intermediary gateway server is as simple as a card reader that has been authorized to access a database such as one found on centralized data server 300. Unlike user device 10, which may not be equipped with a network module 280, intermediary gateway servers 100 always have network connection capacity. Intermediary gateway servers are authorized before they are allowed to access centralized data server 300. For example, when a laptop computer attempts to access the Internet through an Internet or network service provider 40 (one form of intermediary gateway server), a login page prompt the user to submit the device identifier 254 and synthesized security identifier 258. The submitted information will then be verified against the databases on a centralized data server 300. In some embodiments, databases on centralized data server 300 are distributed to multiple sub-servers. In some embodiments, a sub-server hosts identical databases as those found on centralized data server 300. In some embodiments, a sub-server may host specialized databases, for example, only those related to network service authorization.

In some embodiments in accordance with the present invention, an intermediary gateway server may host some of the data structures that are normally stored on centralized data server 300. For example, a specialized service provider, normally as an intermediary gateway server, may build an internal database that includes device identifiers 254, user identifiers 256, and synthesized security identifiers 258. In these embodiments, the internal database server from a specialized service provider essentially becomes a new centralized data server 300 except that access to the internal database server is restricted to user devices from authorized users of the specialized service provider. In these embodiments, user device 10 essentially communicates directly to the internal database server. Within a company, access to a general facility/service or a restricted facility/service may be authenticated by embodiments of the present invention in combination with a radio frequency identification (RFID) system. For example, a proximity card may be created with an embedded device identifier 254 and a synthesized security identifier 258. By scanning the card at a card reader, the device identifier 254 and synthesized security identifier 258 are submitted to the internal database server. General access to a facility/service will be granted accordingly if matches are made by the internal database server. In some embodiments, in order to gain access to a restricted facility/service, user identifier 256 (e.g., a biometric key) will be required. For example, in addition to a proximity card reader, a fingerprint scanner or iris scanner is installed to collect biometric data. The collected data is again submitted to the internal database server for authentication and access to the restricted facility/service is granted or denied accordingly. In these embodiments, a card reader is viewed as an intermediary gateway server 100, though it does not actively request authentication from user devices. Accordingly, the internal database functions as a centralized data server 300.

The RFID-based applications of the triple authentication system are not limited to local area network as described in the above sample. For example, by connecting the card reader and a fingerprint scanner to a broader network, the RFID-based triple authentication system can be expanded to users and user devices that are not restricted to the same geographic location. According, network-based services may be delivered to a broad range of users and user devices.

In some embodiments, the intermediary gateway server includes but is not limited to an Internet service provider, a cellular service provider, a bank computer server, a hospital computer server, a school computer server, a desktop computer, an internet site, a vending machine, a credit card reader, or a proximity card reader. In some embodiments, intermediary gateway server is pre-authorized or pre-registered for access to centralized data server 300. In some embodiments, access to centralized data server 300 is granted per request from intermediary gateway server 100.

5.1.2. Acquiring Synthesized Security Identifiers

In some embodiments in accordance with the present invention, synthesized security identifiers 258 are generated on centralized data server 300 per request from user device 10 via intermediary gateway servers 100. An exemplary process of acquiring and receiving a synthesized security identifier 258 using a user device 10 is outlined in FIG. 4 and described below.

Step 402. In some embodiments, a user starts up a user device 10 in order to initiate the registration process. User device 10 has already been assigned a device identifier 254 and a backup access key 260. Furthermore, user device 10 is linked to a secured network either through its own network module 280 or an external network device (e.g., a credit card reader). Access to the secured network, however, is restricted. Backup access key 260 allows the user device to have access to a secure network in order to register. When user device 10 is powered on, a search for a synthesized security identifier 258 on the device is initiated.

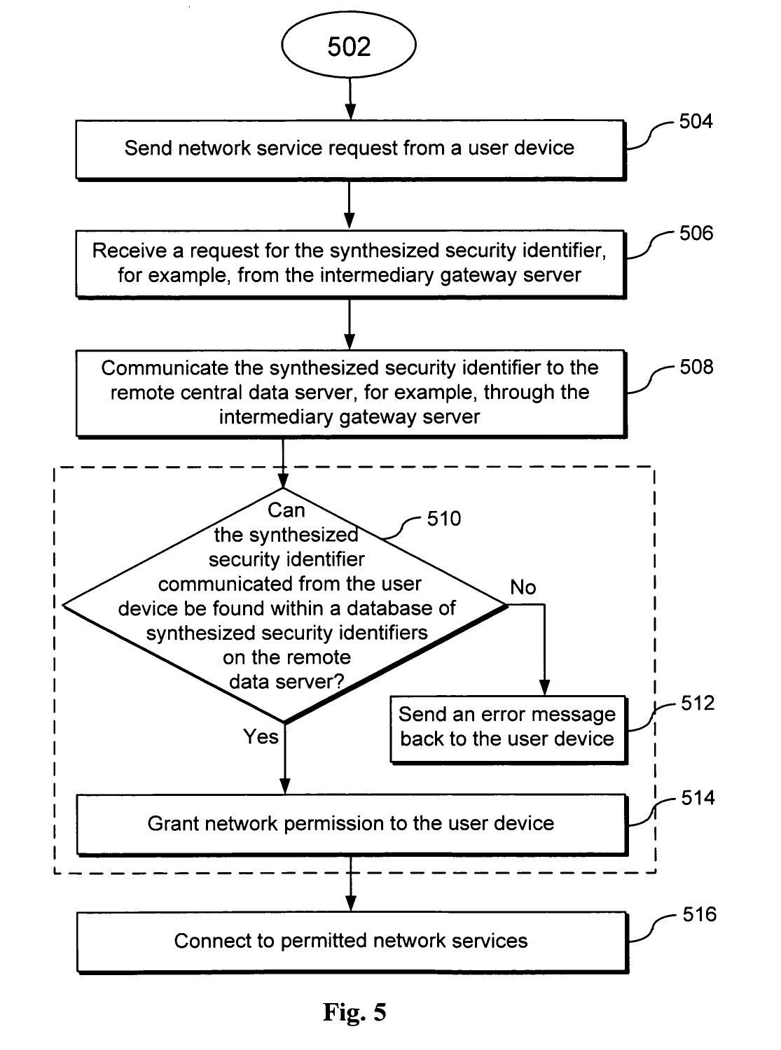

Step 404. If a synthesized security identifier 258 is found (404—Yes), user device 10 can proceed to a network connection process, for example, starting from step 502 as depicted in FIG. 5. If a synthesized security identifier 258 is not found on the device (404—No), process control passes to step 406.

Step 406. At this step, biometric data are acquired in association with user or user device 10. In some embodiments, biometric data are acquired using a built-in biometric acquiring device which is a part of user device 10, for example, a fingerprint on a fingerprint reader embedded in a cell phone or an iris scanner on a laptop computer. In other embodiments, the biometric data are acquired using an external biometric acquiring device. For example, when user device 10 is a credit card, biometric data are acquired using an external fingerprint scanner at the time of registration. In some embodiments, the biometric data are fingerprint scans or iris scans. In some embodiments, biometric data are any physical and behavioral characteristics (e.g., biometric data) for authentication purposes including, but not limited to, measurement of traits such as faces, hands, ears, vein patterns, blood typing, DNA typing, signature and voice pattern. In some embodiments, more than one type of biometric data will be submitted in connection with a particular user device for added security. In one embodiment the device is a cell phone and the biometric data is a voice scan.

Step 408. After biometric data are acquired, the data are submitted to centralized data server 300 via intermediary gateway servers. Because user device 10 has not been registered with centralized data server 300, device identifier 254 of user device 10 will not gain access to network 30 (FIG. 1A) since it cannot pass authentication system 20. In some embodiments in accordance with the present invention, initial access to network 30 is granted through backup access key 260 so that biometric data or device identifiers 254 may be submitted to centralized data server 300. A backup access key 260 serves as a default technical support access key. In the absence of another access key, such as a synthesized security identifier 258, a backup access key 260 allows device 10 to connect to network 30 for limited functionalities, for example, registration or technical support. Accordingly, initial biometric data (e.g., as acquired in previous step 406) are submitted to centralized data server 300 via backup access key 260. In some embodiments, multiple types of biometric data are submitted to centralized data server 300 to ensure accuracy. In all embodiments in accordance with the present invention, in order to ensure security, biometric data are never stored on any device but centralized data server 300 and download access to centralized data server 300 is forbidden or highly restricted. In some embodiments, backup access keys 260 will only grant user device access to customer support tools 348 on centralized data server 300.

Step 410. In some embodiments of the present invention, biometric data is processed on centralized data server 300 using the exemplary process outlined in steps 414 through 420 depicted in FIG. 4B. Once a synthesized security identifier 258 is generated based upon the device identifier 254 of a particular user device 10, it is communicated from centralized data server 300 to the user device 10, for example, through intermediary gateway servers as, for example, depicted in FIG. 1B.

Step 412. When user device 10 receives the synthesized security identifier 258 from centralized data server 300, it stores the identifier 258 permanently. In some embodiments in accordance with the present invention, a user will not be permitted to alter, change, or delete a synthesized security identifier 258 once it is stored on user device 10.

As mentioned above, synthesized security identifiers 258 are generated on centralized data server 300 before they are communicated to user devices 10, for example, through intermediary gateway servers. An exemplary process for generating a synthesized security identifier 258 using a user device 10 is outlined in the following and depicted in FIG. 4B.

Step 414. Centralized data server 300 receives biometric data from a user device 10, for example, through intermediary gateway servers. In addition to the biometric data, a device identifier 254 of user device 10 is also communicated to centralized data server 300 in addition to information such as a time when the biometric data was acquired, personal ownership information of the device user, or any other information that may be used to define user identity or ownership (e.g., an optional user password). In some embodiments, using content management tools 340 (FIG. 3A), the biometric data is stored in one or more searchable data structures (e.g., a database) on centralized data server 300 in its original format. For example, in some embodiments the biometric data is a fingerprint scan and this scan is stored in a database accessible by server 300. In some embodiments, biometric data are standardized into a pre-determined format before being stored in one or more searchable data structures (e.g., a database) on centralized data server 300.

In some embodiments, a user identifier 256 rather than biometric data is submitted. to centralized server 300 in step 414. In such embodiments, step 416, the extraction of a user identifier 256 from biometric data, is not required.

Step 416. At this step, by one or more data processing applications 338 (FIG. 3A), centralized data server 300 extracts characteristic features from the stored biometric data of step 414 to generate one or more user identifiers 256, using, for example, one or more hash functions. The one or more user identifiers 256, along with the original biometric data, are then stored on centralized data server 300 in searchable data structures such as one or more databases.

Step 418. At this step, centralized data server 300 generates a synthesized security identifier 258 for user device 10, for example, utilizing one or more user identifiers 256 associated with the device. In some embodiments, the synthesized security identifier 258 is also generated by one or more data processing applications 338, utilizing not only all or part of the user identifier 256, but also the device identifier 254 of user device 10. In some embodiments, more information is incorporated into the synthesized security identifier 258, such as, for example, the time when the biometric data was acquired, personal ownership information of user device 10, or any other information that will help to uniquely identify the user of the device 10 and/or the device 10 itself. The synthesized security identifier 258 is stored in centralized data server 300 in one or more searchable data structures such as a database. In some embodiments, synthesized security identifiers 258 are encrypted to ensure further security.

Step 420. At this step, newly create synthesized security identifier 258 is communicated from centralized data server 300 to user device 10, thus completing the registration process. Synthesized security identifiers 258 are stored on both centralized data server 300 and user device 10. In some embodiments, synthesized security identifier 258 is encrypted for added security. In some embodiments, synthesized security identifier 258 is permanently stored on user device 10 such that any user will not be able to alter, erase, or replace synthesized security identifier 258 without compromising the function of the device.

### 5.2. A Triple Authentication System

A triple authentication system in accordance with the present invention comprises a device identifier 254 (e.g., an IPv6 address), a user identifier 256 (e.g., a biometric key) and a synthesized security identifier 258. FIG. 3B illustrates an exemplary embodiment of a triple authentication system by illustrating information exchange between user device 10 and a centralized data server 300, which is, for example, facilitated by an intermediary gateway server 100. In this example, centralized data server 300 and intermediary gateway server 100 collectively form the authentication system 20 as depicted in FIG. 1A. The types of identifiers stored on user device 10 and centralized data server 300 are highlighted. For example, user device 10 stores two types of identifiers: device identifier 254 and synthesized security identifier 258. Central device 300, on the other hand, stores pluralities of device identifiers, user identifiers and synthesized security identifiers, thus forming device identifier database 354, user identifier database 356, and synthesized security identifier database 358. Although device identifiers 254 and synthesized security identifiers 258 are stored on both centralized data server 300 and user device 10, in preferred embodiments, no information about user identifiers 256 is stored on user device 10. Such user identifier information is only stored on centralized data server 300, in order to maintain the level of security provided by the triple authentication system.

In some embodiments in accordance with the present invention, a user device 10 can have multiple device identifiers 254 to represent different aspects of its functionality. Such embodiments are useful for facilitating information access and exchange, where data are sliced into numerous segments. The access to different segments can be monitored and verified by the triple authentication system. In some embodiments, it is possible to associate more than one synthesized security identifier 258 to a user device 10. Such embodiments are particularly useful for exchanging and accessing information because it makes data access by multiple authorized users possible.

These sets of identifiers can be utilized in association with any computer operating systems, including Macintosh, Linux, Linux variation, Windows, Unix, and VMS. In some embodiments, one or more operating systems can be used to manage hardware and software performance on centralized data server 300, for example, as operating system 332. In some embodiments, one or more operating systems can be used to manage hardware and software performance on intermediary gateway server 100. In addition, a triple authentication system is compatible with various mobile operating systems, including Symbian, Windows Mobile, Palm OS, and Linux-based operating system from Wind River Systems, Inc. (e.g., VxWorks), Green Hills Software (e.g., INTEGRITY and velOSity RTOS), QNX Inc. (e.g., QNX Neutrino system), LynuxWorks (e.g., LynxOS RTOS) as well as the real-time and embedded product lines of Microsoft (Windows CE and Windows NT Embedded), MontaVista, Timesys and others. These exemplary operating systems can be device embedded and, therefore, suitable for use in user device 10. For example, Symbian OS is an operating system for advanced 2.5G and 3G mobile phones. Symbian OS is designed for mobile devices, with associated libraries, user interface frameworks and reference implementations of common tools. User interface layers for Symbian OS include, but are not limited to, Series 60 by Nokia, UIQ from UIQ Technology and MOAP for NTT DoCoMo. In some embodiments in accordance with the present invention, any operating system that supports the IPv6 standard stack can be utilized in centralized data server 300, intermediary gateway server 100, and/or user device 10.

The triple authentication system is also compatible with any file system. Operating systems have a variety of native file systems. For example, Linux supports file systems such as ext2, ext3, ReiserFS, Reiser4, GFS, GFS2, OCFS, OCFS2, NILFS and Google File System. Linux also has full support for XFS and JFS, along with the FAT and NTFS file systems. Windows supports the FAT12, FAT16, FAT32, and NTFS file systems. Accordingly, any one or combination of the exemplary file systems listed herein, as well as others known to those of skill in the art, may be utilized in any component of the triple authentication system, for example, centralized data server 300, intermediary gateway server 100 or user device 10.

### 5.3. Exemplary Applications of a Triple Authentication System

A triple authentication system in accordance with the present invention allows individualized information to be strictly protected, thus providing a suitable platform for information exchange. A triple authentication system may be adopted in numerous applications to provide a variety of user services, including secured network access, secured financial transaction, safeguarding information access, and protecting personal devices by tagging and tracking the devices.

5.3.1 Secured Network Access

One function of the triple authentication system is to provide secured network services to prevent unauthorized access to an Internet account. Because a synthesized security identifier 258 is uniquely identified and bound to a particular user device 10, it will only grant network access to the designated device. In conventional methods, network access is granted either without any verification or with very limited security, for example, with a simple user login and/or user password. Complete network access may be gained by simply peering over the shoulder of a user during login or by slightly more sophisticated methods such as intercepting a password (that perhaps has been transmitted in a wireless network) or using computer algorithms for password decryption. An exemplary embodiment of a network access session is depicted in FIG. 5 and outlined in the following description.

Step 502. Once a synthesized security identifier 258 has been assigned and stored on a user device 10, the device is capable of accessing a secured network 30.

Step 504. At this step, a user device 10 detects a network service portal. In some embodiments, a network module 280 is an integral part of user device 10. For example, a laptop computer is often equipped with a local area network (LAN) socket and/or a wireless card. Accordingly, network detection is achieved by either physically connecting to a LAN socket with a network cable or by searching for and locating a wireless signal. In some embodiments, external devices are necessary for a user device 10 to detect a network service portal. For example, a credit card itself cannot detect or locate a network. Instead, a credit card reader is needed so that information on the credit card may be accessed through a network. In some embodiments in accordance with the present invention, a credit care reader is connected to a network. Once a network is located, a request for network connection is sent from a user device 10.

In another example, a laptop computer requests Internet access in a public 802.11 wireless network, such as one found in a coffee ship or at the airport. The providers of network service here are intermediary gateway servers 100. For example, an intermediary gateway server 100 can be a wireless hub at an airport, a LAN network provider, or a cellular service provider. In preferred embodiments, intermediary gateway servers 100 are pre-authorized in order to access synthesized security identifiers 258 and device identifiers 254 stored on centralized data server 300.

Step 506. At this step, user device 10 receives a request for a synthesized security identifier 258. In some embodiments in accordance with the present invention, the key request is sent to user device 10 by intermediary gateway server 100, for example, a wireless hub server at the airport. In some embodiments not depicted in FIG. 5, a request for authentication is submitted by user device 10 as it requests a service. For example, a laptop computer submits its request for network service along with its synthesized security identifier 258 and device identifier 254. In some embodiments, it is sufficient to only submit the synthesized security identifier 258.

Step 508. At this step, user device 10 communicates its synthesized security identifier 258 to centralized data server 300 through intermediary gateway server 100. In some embodiments, synthesized security identifier 258 is communicated to centralized data server 300 without being stored on intermediary gateway server 100. In some embodiments, synthesized security identifier 258 is temporarily stored on intermediary gateway server 100 before it is communicated to centralized data server 300. In some embodiments in accordance with the present invention, the device identifier 254 of user device 10 is also communicated to centralized data server 300, either actively or passively (e.g., being detected automatically by centralized data server 300 or intermediary gateway server 100 as a feature of the network). In some embodiments, both device identifier 254 and synthesized security identifier 258 will then be verified against a database stored on centralized data server 300.

Steps 510 though 514 take place on centralized data server 300 and illustrate an exemplary verification process.

Step 510. At step 510, upon receiving synthesized security identifier 258 from user device 10, a search process is launched on centralized data server 300 to verify the synthesized security identifier 258 submitted from user device 10 using, for example, content management tools 340. In some embodiments, both the device identifier 254 of the user device 10 and the synthesized security identifier 258 are verified. As illustrated in the exemplary registration process outlined in steps 402 to 412, the device identifier 254 and synthesized security identifier 258 are linked such that they reflect the identity of a particular user device 10. In some embodiments, all or a part of the device identifier 254 of user device 10 is used to create synthesized security identifier 258. A synthesized security identifier 258 is thus strictly associated with user device 10. In some embodiments in accordance with the present invention, verification step 510 comprises two parts. In the first part, a match for synthesized security identifier 258 among one or more databases on centralized data server 300 is sought. In the second part, a match for the device identifier 254 among one or more databases on centralized data server 300 is sought. A failure of either part of the verification process is optionally recorded on centralized data server 300. If the requisite matches are found (510—Yes) process control passes to step 514. If the requisite matches are not found (510—No) process control passes to step 512.

Step 512. In case of a verification failure, an error message is sent to user device 10. Accordingly, network access is denied for user device 10. User device 10 may select to use its backup access key 260 to report the malfunctioning of a synthesized security identifier 258 and request customer or technical support. In some embodiments, by using system administration and monitoring tools 342, the device identifier 254 of a user device 10 will be recorded to reflect repeated verification failures from a particular user device 10. In some embodiments, the device identifier 254 can be used to track the location of the user device 10 in question.

Step 514. When synthesized security identifier 258 and device identifier 254 of a user device 10 are properly verified, network access permission will be granted by centralized data server 300. In some embodiments, the network access permission is communicated to intermediary gateway server 100. In other embodiments, the network access permission is communicated directly to user device 10.

Step 516. Once the network access permission is granted, user device 10 may freely navigate the network. In some embodiments, the network access verification process is conducted on a session by session basis. For example, a user of a laptop device will only be required to submit synthesized security identifier 258 the first time the device requests access to the airport's wireless service. The user will be able to maintain network access until the laptop device is shut down and/or the Internet session is terminated.

It is to be appreciated that secure network service is provided by only part of a triple authentication system, utilizing only two of the authentication identifiers associated with a user device, namely a device identifier 254 and a synthesized security identifier 258. The security, however, is firmly embedded in the architecture and design of the device identifier 254 and synthesized security identifier 258, controlled by a centralized data server 300. For example, a 512 bit synthesized security identifier 258 is highly secure. It takes up to 52 years to decode a single 512 bits long security code using conventional crypto-cracking algorithms. In addition, device identifier 254 and synthesized security identifiers 258 are firmly embedded within user device 10. Without permission (e.g., from centralized data server 300), attempts to alter either the device identifier 254 or synthesized security identifier 258 will either damage or destroy user device 10. Moreover, when a financial transaction is requested during a network session, further verification is necessary and will be discussed in detail in the following section.

5.3.2 Secured Financial Transaction

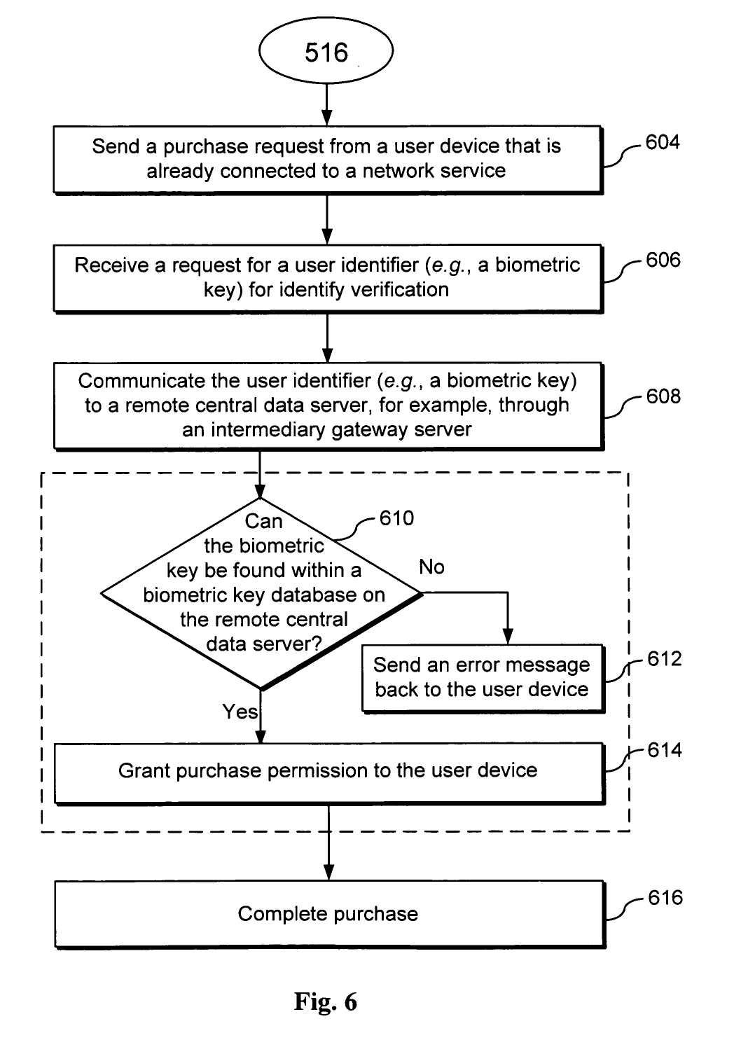

When a user device requests a financial transaction, further verification is required in addition to the synthesized security identifier verification process, thus fully evoking the third authentication element (e.g., a user identifier 256) in addition to the device identifier 254 and synthesized security identifier 258. In some embodiments, network access has already been granted to a user device before a financial transaction is requested. In other embodiments, requests for network access and financial transaction are submitted from a user device at the same time or sequentially. An exemplary financial transaction process is depicted in FIG. 6 and outlined below. It will be appreciated that financial transactions are only one type of application that utilizes the triple authentication system; therefore the examples included in the following discussion should not in anyway limit scope of the present invention.

Step 604. At this step, a request for a financial transaction (for example, a purchase order) is sent from user device 10. In some embodiments, verification of a purchase order is initiated by user device 10 requesting a purchase while connected to a network 30. For example, a cell phone user browses the Internet and subsequently submits a ringtone purchase request. In this case, network security has already been verified when the cell phone is granted access to the cellular network when synthesized security identifier 258 of the cell phone is verified by a remote centralized data server.

In some embodiments, verification of a purchase order is initiated at the time when a user device attempts network connection, for example, when a credit card is inserted into a credit card reader. Here the credit card reader is intermediary gateway server 100 that connects the credit card to a network through a modem like mechanism. Network access security will be verified in accordance with methods outline in the preceding section before the purchase request is verified. It is also possible to submit both requests for verification to centralized data server 300 simultaneously.

Step 606. At this step, user device 10 receives a request for a user identifier 256 from centralized data server 300. In some embodiments, the user identifier is a biometric key such as a fingerprint scan or an iris scan. In some embodiments, the user identifier is a personal password specified by the user of the device at the time of registration or through customer support after the device has been registered.

In some embodiments not depicted in FIG. 6, a request for authentication is submitted by user device 10 as it requests the financial transaction. For example, when a credit card user inserts a credit card into a credit card reader, an authentication query is automatically sent from the credit card reader to the centralized data server 300. In some embodiments, the authentication query comprises synthesized security identifier 258 and device identifier 254 (e.g., an IPv6 address), both associated with user device 10. In some embodiments, the authentication query only comprises the synthesized security identifier 258.

Step 608. At this step, a user identifier is submitted to centralized data server 300. In some embodiments, the user identifier is biometric data that is collected from the owner of user device during or before the transaction request. In some embodiments, biometric data are acquired by using an external device. For example, after the credit is verified by its synthesized security identifier, the fingerprint of the cardholder is acquired by using an external fingerprint scanner, which is then sent to centralized data server 300 for verification.

Steps 610 to 614 take place on centralized data server 300.

Step 610. At this step, a user identifier 256 such as biometric data is received by centralized data server 300 and subsequently verified against one or more data structures (e.g. databases) stored on centralized data server 300. In some embodiments in accordance with the present invention, data processing application 338 on centralized data server 300 is used during the verification process. In other embodiments, content management tool 340 on centralized data server 300 is used during the verification process.

Step 612. In case of a verification failure (610—No), an error message is sent to user device 10. In some embodiments, application and network access is denied for user device 10. User device 10 may select to use its backup access key 260 to report any error during the verification of biometric data and request customer or technical support. In some embodiments, by using system administration and monitoring tools 342, the device identifier 254 of a user device 10 is recorded to reflect repeated biometric verification failures from user device 10. In some embodiments, the device identifier 254 can be used to track the location of the user device 10 in question.

Step 614. When biometric data submitted by the user of a device are properly verified (610—Yes), the purchase request is granted by centralized data server 300. In some embodiments, the purchase permission is communicated to intermediary gateway servers 100. In other embodiments, the purchase permission is communicated directly to user device 10.

Step 616. At this step, the financial transaction is complete. Any data collected by external biometric data acquiring device is cleared such that no biometric data will remain on the device after a purchase is complete.

It is to be appreciated that although the application of the user identifier (e.g., a biometric key) is discussed herein in association with financial transactions, the scope of its application is not limited to financial transaction. In the follow example, a user identifier serves as the final authentication step for information access.

5.3.3 Secured Remote Financial Transaction

Remote financial transactions using a credit card embedded with a triple authentication system occurs differently from those taking place within the stores where credit card readers are readily available. For example, a user may use the credit card from a pre-authenticated device (e.g., a mobile device such as a cell phone or a laptop computer), for example, by methods in accordance with the present invention. By bundling the credit card with the pre-authenticated device, a user may request financial transactions without submitting the synthesized security identifier for the credit card, for example, in the absence of a credit card reader. Instead, the user may simply submit a regular credit card number. A request for user identifier (e.g., a biometric key) will be made through the mobile device. If the pre-authorized device is equipped with a biometric collecting device, biometric data such as a fingerprint scan or iris scan will be submitted in order to approve such financial transaction. In most embodiments, a request for biometric data may be sent to a pre-authorized device equipped with a biometric data collecting device where the user chooses to submit biometric data. In rare embodiments, in the absence of a biometric collecting device, a user defined password will be submitted in place of a biometric key.

In other embodiments, when a credit card is used from an unauthorized source then the card user must use the number on the card to identify the holder. This card number in turn is linked to a set of triple identifiers stored on the centralized data server. A user identifier must still be submitted. For example, when the credit card number is entered, a request for the triple authentication identifiers associated with the credit card is sent to the centralized data server. The unauthorized device will be flagged which, in some embodiments, triggers the central data server to delay authorization response to the merchant and send an SMS to a pre-authorized device that is associated with the credit card, for example, a mobile phone equipped with a fingerprint scanner. The user will need to respond before the financial transaction is finalized. If no portable biometric device is available then the to-be-purchased items will remain pending until access to a biometric collecting device is secured. Otherwise the to-be-purchased item request expires.

5.3.4 Secure Access to Compartmentalized Data

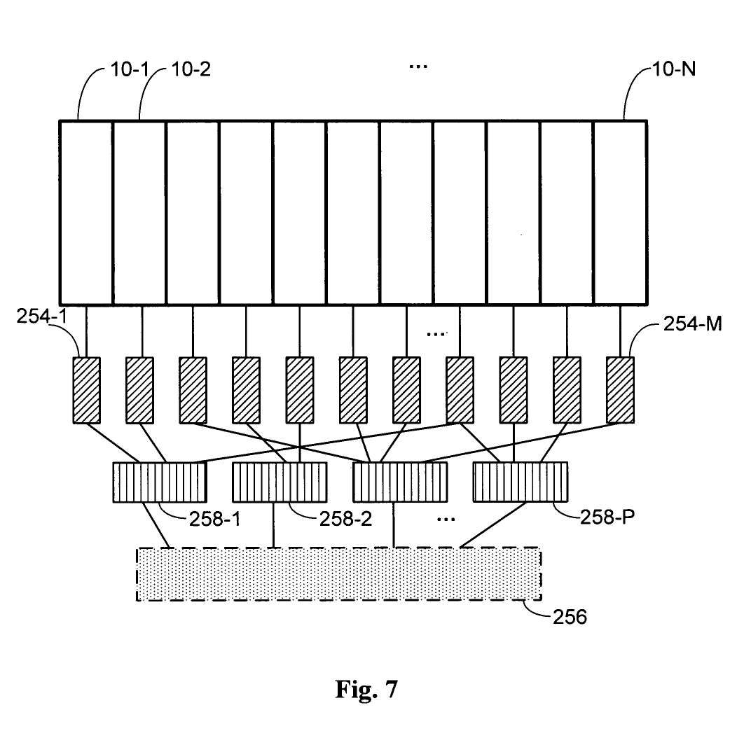

In some embodiments in accordance with the present invention, the triple authentication methods are applied to more complex systems. Referring to FIG. 7, user device 10 refers to a block of data, for example, medical records, student records, or any other complex data forms. The complex data can be broken into segments 10-1, 10-2, . . . , 10-N. In some embodiments, the segmented data can be further compartmentalized based on certain common characteristics. To each data segment, a device identifier 254 is assigned, for example, as depicted in FIG. 7. These device identifiers serve as call numbers or pointers to data segments. Each device identifier 254 is further associated with one or more synthesized security identifiers 258, as depicted in FIG. 7. In some embodiments, one data segment 10 is only linked with one synthesized security identifier 258. In some embodiments, one data segment is linked with multiple synthesized security identifiers 258. In other embodiments, multiple data segments are linked with one or more synthesized security identifier 258. In some embodiments, a data segment represents a portion of the medical records of a particular patient, for example, a particular type of treatment for the patient.

In the exemplary embodiment in accordance with FIG. 7, a patient receives 11 different treatments. These treatments, in turn, are supervised by 4 different physicians, each of whom is equipped with a synthesized security identifier 258 as depicted in FIG. 7. With a synthesized security identifier 258, each of the physicians is authorized with limited access to a part or all of the patient's records. In embodiments in accordance with the present invention, a synthesized security identifier 258 here provides a first level of authorization to the physicians so that they may have basic access to the patient's medical records to conduct general searches. In these embodiments, synthesized security identifiers 258 are generated not based on biometric data from any particular patient, but based on the specialty and affiliation of the particular physician. In order to gain full access to a particular record, however, an additional level of access authorization is necessary, for example, by supplying a user identifier 256 of the patient. In one example, the user identifier 256 is a biometric key collected from the patient. Upon receiving a request for data access from a physician, the patient can go to a doctor's office to submit a biometric key for authorization. Alternatively, the patient can submit a biometric key dynamically through a portable device (e.g., a cell phone equipped with a fingerprint scanner, a PDA, or other handheld devices equipped with biometric data collecting modules).

The exemplary embodiments for data access and exchange are discussed in accordance with the organization and assignment of the triple identifiers. In some embodiments, each type of identifies may have additional characteristics. For example, in some embodiments, a user identifier may comprise more than one type of biometric data to further improve security. In some embodiments, the added security is achieved by an encrypted user password.

In some embodiments, access to a patient's medical records is encoded in synthetic security identifiers of authorized medical professionals. In some embodiments, the synthetic security identifiers associated with the medical records encodes information for authorized medical professionals. In some embodiments, the synthetic security identifiers associated with the medical records may be modified such that authorization to a medical professional may be added or revoked. In some embodiments, such modifications reflect a change in an association between the synthesized security identifier and a device identifier or a user identifier.

5.3.5 Protecting User Devices

Under the current technology, stolen or lost devices, such as cell phones, laptops and PDAs, can be reused either by the thief or whoever has found the device. The original owner suffers a financial loss due to the cost of these increasingly sophisticated devices. In addition, information stored on the device may be misused, therefore subjecting the original owner to further vulnerability. For example, in some countries, financial transactions conducted on a cell phone device are billed as part of the owner of the cell phone service charges. A lost or stolen cell phone thus can create substantial financial loss to its owner. By using a triple authentication system, losses related to stolen or lost devices are mitigated.

In some embodiments in accordance with the present invention, an individual having a user device is required to enter a unique user identifier to ensure ownership protection. For example, a user is asked to input a user identifier 256 to conduct a financial transaction. The user identifier 256 can be either raw biometric data collected in real time from the user or a user-defined password, both of which are only stored on centralized data server 300 and not on user device 10. For example, a cell phone equipped with a fingerprint scanner provides the additional protection of a user identifier. In some embodiments, a user is asked to input a user identifier periodically according to a pre-determined schedule. In some embodiments, a user is asked to input a user identifier at times of financial transaction. In some embodiments, the original owner of a stolen device may report the loss, either through email, a customer support phone line or on a web interface. The reports are processed by customer support tools 348 on centralized data server 300. In response, centralized data servers 300 send out request for a user identifier to the alleged lost or stolen device. When the user of the alleged lost or stolen device fails to provide a valid user identifier, all access and services related to the lost or stolen devices will be denied accordingly.

Using currently available technologies, it is possible to duplicate the functionality of a device. The imposter free rides upon the existing service and thus deprives the owner's exclusive rights. Furthermore, expenses incurred on the duplicated device may be imputed to the innocent owner. In embodiments in accordance with the present invention, identity theft (e.g., free-riding by duplication) may be mitigated by employing the IPv6 network. IPv6 operates without subnets and is considered a flat network. For example, if two cell phones pop up on the same network sharing, for example, the same IPv6 address, they will be automatically detected by the IPv6 network and negate each other. Accordingly, a duplicate device is disabled to protect the interest of the rightful owner.

5.3.6 Computer Program Product

The present invention can be implemented as a computer program product that comprises a computer program mechanism embedded in a computer readable storage medium. Further, any of the methods of the present invention can be implemented in one or more computers or computer systems. Further still, any of the methods of the present invention can be implemented in one or more computer program products. Some embodiments of the present invention provide a computer system or a computer program product that encodes or has instructions for performing any or all of the methods disclosed herein. Such methods/instructions can be stored on a CD-ROM, DVD, magnetic disk storage product, or any other computer readable data or program storage product. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods encoded in the computer program product can also be distributed electronically, via the Internet or otherwise, by transmission of a computer data signal (in which the software modules are embedded) either digitally or on a carrier wave.

Some embodiments of the present invention provide a computer program product that contains any or all of the program modules shown in FIGS. 1A, 1B, 3A, and 3B. These program modules can be stored on a CD-ROM, DVD, magnetic disk storage product, or any other computer readable data or program storage product. The program modules can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. The software modules in the computer program product can also be distributed electronically, via the Internet or otherwise, by transmission of a computer data signal (in which the software modules are embedded) either digitally or on a carrier wave.

### 6. REFERENCES CITED

All references cited herein are incorporated herein by reference in their entirety and for all purposes to the same extent as if each individual publication or patent or patent application was specifically and individually indicated to be incorporated by reference in its entirety for all purposes.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

What is claimed:

1. A method for authenticating a query device using a centralized data server comprising:
(a) associating and storing, on the centralized data server, for each respective device in a plurality of devices, a device identifier, a user identifier, and a synthesized security identifier that collectively authenticate the respective user device;
(b) receiving, at the centralized data server, an authentication request from an intermediary gateway server that seeks verification of an identity of the query device, wherein the authentication request comprises a query device identifier or a query synthesized security identifier;
(c) attempting to verify, at the centralized data server, the query device by searching for a match between the query device identifier and a stored device identifier or by searching for a match between the query synthesized security identifier and a stored synthesized security identifier, wherein
when a first match is made between (i) one of the query device identifier and the query synthesized security identifier and (ii) a corresponding device identifier or synthesized security identifier stored on the centralized server and associated with a target device in the plurality of devices, the identity of the query device is verified provided that a second match is made between (i) the other of the query device identifier and the query synthesized security identifier and (ii) a corresponding device identifier or synthesized security identifier stored on the centralized server and associated with the target device; and
(d) communicating, from the centralized data server, whether the identity of the query device is verified to the intermediary gateway server.

2. The method of claim 1, wherein the intermediary gateway server is an Internet service provider, a cellular service provider, a bank computer server, a hospital computer server, a school computer server, a desktop computer, an Internet site, a vending machine, a credit card reader, or a proximity card reader.

3. The method of claim 1, wherein the intermediary gateway server is pre-authorized or pre-registered with the centralized data server.

4. The method of claim 1, wherein the intermediary gateway server is temporarily authorized or registered with the centralized data server in order to receive said authentication request and wherein when the query device is verified said intermediary gateway server is permanently authorized or registered with the centralized data server.

5. The method of claim 1, wherein the query device is a cell phone, a personal digital assistant (PDA), an iPod, a credit card, a mobile device equipped with a fingerprint scanner, a desktop computer, a laptop computer, or a networked device.

6. The method of claim 1, wherein the query device is a credit card accessed by a network device.

7. The method of claim 1, wherein the query device is connected to a network through an external network module.

8. The method of claim 1, wherein the intermediary gateway server grants the query device access to an Internet session or network-based transaction when the identity of the query device is verified by the centralized data server.

9. The method of claim 1, wherein the query device identifier comprises an IPv6 address of the query device.

10. The method of claim 1, wherein the query device identifier comprises an IPv4 address, a public key infrastructure (PKI) key, a virtual private network (VPN) key, a radio frequency identification (RFID) tag number, a public key cryptography number, a credit card number, or a machine serial number.

11. The method of claim 1, wherein a user identifier associated with a device in the plurality of devices comprises a biometric key.

12. The method of claim 11, wherein the biometric key is extracted from biometric data from a user of the query device.

13. The method of claim 12, wherein the biometric data comprises a measurement of a physical trait of the user of the query device selected from the group consisting of a facial thermogram, a finger print, an iris scan, and a hand geometry measurement.

14. The method of claim 12, wherein the biometric data comprises a measurement of a physical trait of the user selected from the group consisting of a vein pattern, an ear shape, an analysis of a body odor, and an analysis of nucleic acid material obtained from the user.

15. The method of claim 12, wherein the biometric data comprises a behavioral characteristic of the user selected from the group consisting of a hand signature pattern, a keystroke dynamic and a gait pattern.

16. The method of claim 12, wherein the biometric data comprises a voice pattern of the user.

17. The method of claim 1, wherein a user identifier associated with a device in the plurality of devices comprises a user password.

18. The method of claim 1, wherein a synthesized security identifier associated with a device in the plurality of devices is derived from a user identifier associated with the device.

19. The method of claim 1, wherein a synthesized security identifier associated with a device in the plurality of devices is derived from a biometric key associated with the device.

20. The method of claim 1, wherein a synthesized security identifier associated with a device in the plurality of devices is derived from a device identifier.

21. The method of claim 1, wherein a device identifier associated with a device in the plurality of devices is at least 32 bits in length.

22. The method of claim 1, wherein a device identifier associated with a device in the plurality of devices is at least 64 bits in length.

23. The method of claim 1, wherein a device identifier associated with a device in the plurality of devices is at least 128 bits in length.

24. The method of claim 1, wherein a device identifier associated with a device in the plurality of devices is at least 256 bits in length.

25. The method of claim 1, wherein a device identifier associated with a device in the plurality of devices is at least 512 bits in length.

26. The method of claim 1, wherein a synthesized security identifier associated with a device in the plurality of devices is between 128 bits and 512 bits in length.

27. The method of claim 1, wherein a synthesized security identifier associated with a device in the plurality of devices is up to 128 bits in length.

28. The method of claim 1, wherein a synthesized security identifier associated with a device in the plurality of devices is up to 1024 bits in length.

29. The method of claim 1, wherein a synthesized security identifier associated with a device in the plurality of devices is up to 2048 bits in length.

30. The method of claim 1, wherein a user identifier associated with a device in the plurality of devices is at least 16 bits in length.

31. The method of claim 1, wherein a device identifier associated with a device in the plurality of devices is at least 32 bits in length.

32. The method of claim 1, wherein a device identifier associated with a device in the plurality of devices is at least 96 bits in length.

33. The method of claim 1, wherein a device identifier associated with a device in the plurality of devices is at least 128 bits in length.

34. The method of claim 1, wherein a device identifier associated with a device in the plurality of devices is at least 256 bits in length.

35. The method of claim 1, wherein the authentication request of step (b) comprises both the query device identifier and the query synthesized security identifier.

36. The method of claim 1, wherein the attempting step (c) further comprises
obtaining the query synthesized security identifier from the intermediary gateway server once a match between the query device identifier and the device identifier stored on the centralized server is made.

37. The method of claim 1, wherein the attempting step (c) further comprises
obtaining the query device identifier from the intermediary gateway server once a match between the query synthesized security identifier and the stored synthesized security identifier is made.

38. The method of claim 1 wherein
the authentication request further comprises a query user identifier; and
the attempting step (c) further requires a match between the query user identifier and a user identifier that is both (i) stored on the centralized data server and (ii) associated with the target device in order to verify the identity of the query device.

39. The method of claim 38, wherein the query user identifier is biometric data collected by the query device.

40. The method of claim 38, wherein the query user identifier is biometric data collected by a device that is external to the query device.

41. The method of claim 38, further comprising
(e) transmitting a request for a user identifier to a networked device associated with the query device when the query device does not have network capacity.

42. The method of claim 44, wherein the transmitting step (e) is conducted on the centralized data server.

43. The method of claim 44, wherein the transmitting step (e) is conducted on the intermediary gateway server.

44. The method of claim 1, wherein the synthesized security identifier associated with the target device is derived by the centralized data server from both the device identifier and a user identifier associated with the target device.

45. The method of claim 1, wherein the synthesized security identifier associated with the target device is derived by the centralized data server from a time of activation associated with the target device.

46. The method of claim 1, wherein a device identifier associated with a device in the plurality of devices is derived using an encoding algorithm or encryption algorithm.

47. The method of claim 1, wherein a synthesized security identifier associated with a device in the plurality of devices is derived using an encoding algorithm or an encryption algorithm.

48. The method of claim 1, wherein a user identifier associated with a device in the plurality of devices is derived using an encoding algorithm or an encryption algorithm.

49. The method of claim 1, wherein a synthesized security identifier associated with a device in the plurality of devices is modified to reflect a change in an association between the synthesized security identifier and a device identifier or a user identifier.

50. A computer system comprising,
a central processing unit;
a memory coupled to the central processing unit, the memory storing instructions for carrying out the method of claim 1.

51. A computer program product for use in conjunction with a computer system, the computer program product comprising a computer readable storage medium and a computer program mechanism embedded therein, the computer program mechanism for authenticating a query device using a centralized data server, the computer program mechanism comprising instructions for carrying out the method of claim 1.
